(19) United States
(12) Patent Application Publication
(10) Pub. No.: US 2025/0071700 A1
(43) Pub. Date: Feb. 27, 2025

(54) RADIO RESOURCE MANAGEMENT FOR REDUCED CAPABILITY USER EQUIPMENT

(71) Applicant: Apple Inc., Cupertino, CA (US)

(72) Inventors: Jie CUI, San Jose, CA (US); Dawei ZHANG, Saratoga, CA (US); Hong HE, San Jose, CA (US); Huaning NIU, San Jose, CA (US); Manasa RAGHAVAN, Sunnyvale, CA (US); Qiming LI, Beijing (CN); Xiang CHEN, Campbell, CA (US); Yang TANG, San Jose, CA (US)

(21) Appl. No.: 18/726,758

(22) PCT Filed: Jan. 5, 2022
(86) PCT No.: PCT/CN2022/070302

§ 371 Date: Jul. 3, 2024

(51) Int. Cl. H04W 56/00

(52) U.S. Cl. CPC H04W 56/001; H04W 56/0055

(57) ABSTRACT

Systems and methods for operating a 5G NR. In particular, a reduced capability (RedCap) user equipment (UE) can be configured to traverse a synchronization raster to locate a cell-defining synchronization signal block (CD-SSB). The CD-SSB can be used to derive, calculate, or otherwise obtain time/frequency information of a non-cell-defining synchronization signal block (NCD-SSB) which may be monitored and/or measured by the RedCap UE in a more power efficient manner.

### CROSS-REFERENCE TO RELATED APPLICATION

This application is a 35 U.S.C. § 371 application of PCT/CN2022/070302, filed on Jan. 5, 2022, and entitled “Radio Resource Management for Reduced Capability User Equipment,” which is incorporated herein by reference as if fully disclosed herein.

### TECHNICAL FIELD

Embodiments described herein relate to systems and methods for managing power consumption of user equipment and, in particular, to radio resource management (RRM) and synchronization signal processing/locating technique for reduced capability (RedCap) user equipment in 5G NR networks.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN). Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB). A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 shows a scenario (Scenario 1) in which a RedCap UE is within the coverage area for Cell 1.

FIG. 2 shows a scenario (Scenario 2) in which a RedCap UE is within the coverage area for Cell 1 and the coverage area for Cell 2.

FIG. 3 is a simplified flow chart corresponding to a method of operating a RedCap UE, such as described herein.

FIG. 4 is a simplified flow chart corresponding to another method of operating a RedCap UE, such as described herein.

FIG. 5 is a simplified flow chart corresponding to another method of operating a RedCap UE, such as described herein.

FIG. 6 is a simplified flow chart corresponding to another method of operating a RedCap UE, such as described herein.

FIG. 7 is a simplified flow chart corresponding to another method of operating a RedCap UE, such as described herein.

FIG. 8 is a simplified flow chart corresponding to another method of operating a base station of a 5G NR network, such as described herein.

FIG. 9 illustrates an example architecture of a wireless communication system, according to embodiments disclosed herein.

FIG. 10 illustrates a system for performing signaling between a wireless device and a network device, according to embodiments disclosed herein.

The use of the same or similar reference numerals in different figures indicates similar, related, or identical items.

Certain accompanying figures include vectors, rays, traces and/or other visual representations of one or more example paths-which may include reflections, refractions, diffractions, and so on, through one or more mediums—that may be taken by, or may be presented to represent, one or more photons, wavelets, or other propagating electromagnetic energy originating from, or generated by, one or more antennas shown or, or in some cases, omitted from, the accompanying figures. It is understood that these simplified visual representations of electromagnetic energy regardless of spectrum (e.g., radio, microwave, VHF, UHF, millimeter wave and so on), are provided merely to facilitate an understanding of the various embodiments described herein and, accordingly, may not necessarily be presented or illustrated to scale or with angular precision or accuracy, and, as such, are not intended to indicate any preference or requirement for an illustrated embodiment to receive, emit, reflect, refract, focus, and/or diffract light at any particular illustrated angle, orientation, polarization, or direction, to the exclusion of other embodiments described or referenced herein. Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to 5G NR networks. In particular, embodiments described herein related to cell search procedures and communication protocols that may be leveraged by RedCap devices (and/or other UE) to find, synchronize with, and/or identify a cell of a 5G NR network in a power efficient manner. As may be appreciated, before a UE can communicate with and/or perform measurements related to an existing connection with a 5G NR network or cell, the UE must perform one or more cell search operations to obtain basic network, cell, and/or system information. This synchronization information is necessary to communicably couple to a particular cell of a particular 5G NR network so that the UE can transmit and/or receive information via the network.

After synchronization information is obtained by the UE, the UE may camp on a particular cell and thereafter monitor system information of the camped cell and/or neighboring cells to determine (according to UE-specific, cell-specific, or network-specific rules or criteria) whether cell reselection should be performed. In other cases, the UE may be mobile and may periodically initiate or perform, or participate in, one or more handover or cell reselection procedures. More specifically, a UE configured to operate in a 5G NR network may be configured to detect downlink Synchronization Signals (SS) in a Synchronization Signal Block (SSB), specific to a particular cell in the 5G NR network. In particular, an SSB can be defined (in the time domain) by four or more OFDM symbols spanning 20 Physical Resource Blocks (PRBs) defined over 240 subcarriers that encode a Primary Synchronization signal (PSS), a Secondary Synchronization Signal (SSS), and a Physical Broadcast Channel (PBCH). The PBCH in turn, encodes system information (including but not limited to a Master Information Block (MIB), system information block (SIB), and so on) that can be parsed by the UE and used to communicate with the cell and/or to perform one or more measurements. Because each SSB (or more particularly each PSS and SSS combination), is specific to a particular cell, SSBs are often more precisely identified as cell-defining SSBs or “CD-SSBs.”

As may be known, a meaningful difference between LTE and 5G NR networks is that CD-SSB information in 5G NR is not always located (in the frequency domain) at the center of a particular carrier, as is the case with LTE. Although locating synchronization information at a center of a carrier is consistent and convenient in some circumstances for certain UE, LTE UE cell search nevertheless required searching through all possible carriers by traversing the “carrier raster.” This iterative search may be a time consuming and resource consuming process.

By contrast, for 5G NR, CD-SSBs are not required to be broadcast at a center of a particular carrier; CD-SSBs can be located substantially anywhere. As such, a 5G NR UE traverses a sync raster which identifies a limited subset of possible CD-SSB locations. In many cases, the sync raster defines a meaningfully smaller address/location space than an LTE carrier raster, thereby enabling 5G NR UE to locate CD-SSBs associated with a particular cell more quickly than LTE UE counterparts.

In many implementations, CD-SSBs may be transmitted in sets referred to as bursts or burst sets (e.g., sets of SSBs sent in a burst, indexed). Each CD-SSB of a burst may be indexed and may in many implementations be associated with a different beam of a particular cell. In this manner, a UE performing cell search in a 5G NR network can leverage an index of a particular CD-SSB to select a particular beam from a particular cell of a particular network. In other cases, beams may not significantly overlap; a UE may only be able to detect a single CD-SSB associated with a single beam transmitted from a single cell of a 5G NR network.

It may be further appreciated that a UE traversing the sync raster to find a CD-SSB in order to communicably couple to a cell, must necessarily be able to, and configured to, determine which received symbols in a particular half-frame (e.g., 10 ms frame) correspond to, and/or should be parsed/interpreted as, an SSB. More specifically, a UE in a 5G NR network must be capable to assign a symbol index, for a given subcarrier spacing, for candidate CD-SSBs according to the 5G NR specification. In many cases, a UE may adopt a particular half-frame assumption, presuming that a CD-SSB will be broadcast in a first half-frame or a second half-frame. In addition, as known to a person of skill in the art, CD-SSB are required by the 3GPP specification to be broadcast on a repeated basis, typically with a periodicity of 20 ms. In other words, a particular CD-SSB (e.g., associated with a particular beam of a particular cell) is typically rebroadcast every 20 ms. Each subsequent CD-SSB can include similar, identical, or updated information that may be leveraged by a UE to perform one or more operations, such as defining a measurement object for a UE, determining/selecting a particular beam, determining whether to transition to an idle state, whether to set camp to on, whether to initiate a handoff procedure, whether to initiate a cell reselection procedure, and so on.

Generally and broadly, it may be appreciated that locating, receiving, and monitoring CD-SSBs are essential operations for any UE configured to operate in a 5G NR network. In some cases, UE may be required to periodically re-traverse the synchronization raster or otherwise retune RF signal processing chains to receive CD-SSBs broadcast in different sync raster locations. These foregoing described requirements may be undesirably power-demanding and computationally-intensive for certain RedCap UE, which as known to a person of skill in the art are specifically configured for reduced capability sets or limited purposes. Example RedCap devices include, but are not limited to: wearable devices; sensing devices; internet of things devices; implantable devices; vehicle sensors; accessory devices; tracking devices; industrial control devices; and so on. RedCap UE devices are often configured to transmit and/or receive data on an infrequent or reduced-bandwidth basis. RedCap UE are thus typically manufactured to be as simple and inexpensive as possible. More broadly, in many cases, RedCap UE are manufactured with limited system bandwidth and/or may be configured to operate only in a limited bandwidth; in such examples, a RedCap UE may not be able to readily or easily detect CD-SSB that are located outside of the bandwidth of that RedCap UE. For example, a RedCap UE configured to operate in a first band (e.g., FR1) may be positioned within a cell operating in another band (e.g., FR2). In this example, CD-SSBs from the cell may be broadcast within FR2.

In this example, if the RedCap UE is to connect to, and maintain connection with, the 5G NR network, the RedCap UE may be required to retune RF signal processing chains to detect CD-SSB every 20 ms (or on another very frequent basis), before retuning back to FR1. This constant tuning and retuning wastes power, and causes communication interruptions between the RedCap UE and the 5G NR network.

In other examples, a RedCap UE may not be required to retune in order to receive CD-SSBs. In these examples, however, it may not be energy efficient for particular RedCap UE to parse CD-SSBs with 20 ms periodicity; a longer period may be more power efficient or otherwise more optimal.

Further, for certain RedCap UE, it may not be optimally energy efficient to execute cell search operations, such as described generally and broadly above, to locate CD-SSBs each time a RedCap UE wakes from an idle state in order to transmit or receive information from a 5G NR network.

These foregoing described inefficiencies, among others, may reduce the usefulness, relative simplicity, and lower cost, of RedCap UE compared with full capability UE operated in 5G NR networks.

To efficiently accommodate RedCap UE in 5G NR networks, a number of solutions have been proposed, many of which require fundamental modification to the 5G NR specification. For example, one solution may be to provide a mechanism for a UE to identify to a cell functionality provided by or conversely, not provided by, that UE. In such proposals, a single cell may be configured to transmit device-type-specific CD-SSBs, so that different device types can acquire and monitor necessary network information. However, such solutions are likely to introduce substantial complexity to the 5G NR specification which in turn may lead to fragmentation of the standard and/or fragmentation of a network (e.g., certain cells may be designed specifically to operate with particular device types, thereby introducing service gaps for different typed devices).

Furthermore, requiring cell base stations to be configured to accommodate a number of discrete UE types may result in a base station itself being operated inefficiently. In yet other cases, requiring cell base stations to be configured to accommodate a number of discrete UE types may result in inefficient or suboptimal spectrum usage, thereby reducing overall network resource utilization efficiency. As such, modifying the 5G NR specification to accommodate different UE types and/or functionality sets may not be an optimal solution to improve operational efficiency for RedCap devices and/or 5G NR networks.

In 3GPP Release 17 (Rel-17), an SSB modification specific to RedCap UE is proposed, and introduces a non-cell-defining SSB (NCD-SSB). NCD-SSB, as proposed, is defined by a network and is not specific to a particular cell. The block, as proposed, is substantially similar to CD-SSB in the time domain (e.g., four OFDM symbols including PSS, SSS, and PBCH), but is located in the frequency domain within a typical/defined system bandwidth of RedCap UE.

As noted above, the proposed NCD-SSB contains network-specific information, and is not particular to (e.g., does not on its own identify) a particular serving cell or non-serving cell participating in that network. In this manner, a RedCap UE can obtain, monitor, and/or measure network-specific information (e.g., measurement objects, measurement gaps) in an efficient manner without necessarily regularly communicably coupling to, and/or camping on, a particular cell of that network.

This proposed architecture can introduce a number of benefits for both RedCap UE and 5G NR networks including but not limited to: allowing RedCap UE to monitor network information without maintaining a connection of a particular cell; allowing cells to service more full capability UE when RedCap UE communications are not required; allowing RedCap UE to monitor network information at a reduced interval compared to full capability UE, thereby reducing processing requirements of the RedCap UE (e.g., slower interval may result in a longer time period over which PBCH data can be parsed, and thus RedCap UE processors may be lower-power and/or lower complexity).

However, just as with CD-SSB, the proposed NCD-SSB requires a RedCap UE to be configurable to locate, detect, and/or monitor NCD-SSB. This requirement introduces several design challenges, solutions to which have not been contemplated as a part of the proposal. For example, NCD-SSB if broadcast in the same half-frame with CD-SSB in different frequency space may cause a condition requiring a particular cell to power boost two separate signals simultaneously, which may be challenging for a network and/or cell to support. Further, because NCD-SSB has a greater periodicity than CD-SSB (e.g., a longer period of time between NCD-SSB transmissions than between CD-SSB transmissions; a first periodicity compared against a different, second periodicity), search procedures that may be required of RedCap UE may take significantly longer than CD-SSB based cell search procedures. For example, traversing a sparse sync raster to locate a CD-SSB, a UE may be required to linger at each location for at least 20 ms before determining that traversal should continue. By contrast, traversing a sparse sync raster to locate an NCD-SSB, a RedCap UE may be required to linger at each location for at least 40 ms before determining that traversal should continue, at a minimum doubling time required to traverse the sync raster. In yet other examples, it may be difficult without cell-specific information to reduce channel estimation complexity for UE.

These foregoing example problems and/or challenges that may accompany introduction of the proposed NCD-SSB are not exhaustive; many challenges exist for both 5G NR cells and RedCap UE. Embodiments described herein account for these and other inefficiencies and implementation challenges, of the proposed NCD-SSB.

In particular, embodiments described herein reference systems and methods for operating a RedCap UE to leverage NCD-SSBs in addition to, and/or in place of, CD-SSBs so that the RedCap UE can operate more efficiently, thereby extending its operational life and/or reducing its manufacturing complexity and/or cost. More particularly, embodiments described herein reference systems and methods for locating NCD-SSBs and leveraging network-level information communicated with NCD-SSBs for, as one example, serving cell and non-serving cell measurements by RedCap UE.

Example measurements (or measurement objects, gaps and so on) include but may not be limited to idle state measurements, inactive state measurements, connected mode measurements and so on. These measurements (or other information aggregation or parsing operations) can inform radio resource management (RRM) decisions of the RedCap UE, radio link monitoring (RLM) operations for the RedCap UE, serving cell link recovery operations, random access occasion selections, mobility modes/settings, time/frequency tracking, automatic gain control, and so on. In other cases, measurement objects and/or measurement gaps may be supplied or implied by a CD-SSB and/or an NCD-SSB. In some cases, specified measurement objects in a CD-SSB can be applied to subsequently-received NCD-SSBs.

In some cases, a measurement gap (MG) may be required by a particular UE or RedCap UE to receive a CD-SSB and/or an NCD-SSB as described herein. In some cases, such measurement gaps may be specific to a particular network, a particular cell, a particular UE, or a particular UE type (e.g., RedCap UE). In some cases, an MG associated with receiving a CD-SSB may be prioritized over an MG associated with receiving an NCD-SSB, but this may not be required of all embodiments.

For example, many embodiments described herein relate to methods of operating a RedCap UE to first obtain a CD-SSB from a serving cell or a non-serving sell, and to obtain from that CD-SSB timing information that identifies a location of a corresponding NCD-SSB broadcast within the same network and/or from the same cell. Thereafter, the RedCap UE can retune internal RF signal processing chains to thereafter monitor the NCD-SSB, which may be broadcast from either a serving cell or a non-serving cell at a greater periodicity than the CD-SSB. In some cases, a master information block (MIB) and/or a system information block (SIB) extracted from the PBCH of the CD-SSB can contain direct information locating corresponding NCD-SSB(s). In other cases, the MIB or SIB can include a reference to a reduced synchronization raster that can be used by a RedCap UE to locate an NCD-SSB in another frequency location, different from the CD-SSB. In yet other cases, the RedCap UE can be preconfigured by a network provider to monitor specific locations for NCD-SSB, foregoing any requirement to monitor for any CD-SSB.

In some cases data/control channel scheduling can be muted on one FR when measurement is configured on other another FR within same symbols. In yet other examples, measurement configuration may be muted on one FR when data/control channel is scheduled on other FR within same symbols.

In yet other examples, a RedCap UE can be configured to infer, calculate, or derive NCD-SSB timing/location information (also referred to as timing/frequency information or T/F information) from a received CD-SSB. For example, a cell may transmit an NCD-SSB at a fixed interval after certain CD-SSBs (in the same or a different band).

In some cases, transmission of CD-SSBs and NCD-SSBs may occur simultaneously, in different frequency bands. In other cases, a RedCap UE may adopt a different half-frame assumption for NCD-SSBs than for CD-SSBs. For example, the RedCap UE may be configured to assume CD-SSBs are transmitted in a first half-block and that NCD-SSBs are transmitted in the second half-block. In many cases, a network-level restriction or configuration may be made to restrict all NCD-SSBs to be transmitted from all cells in the same half frame. In these examples, any RedCap UE may be able to skip operations associated with determining which half-frame an NCD-SSB is associated with, thereby reducing operational complexity and/or computational requirements for the RedCap UE.

In other cases, as noted above, CD-SSBs and NCD-SSBs may be transmitted in different half frames specifically so a given cell may not be required to boost power for two symbols in two different frequency bands simultaneously. In some cases, a periodicity of an NCD-SSB can be inferred, calculated, or derived from a known periodicity of a received CD-SSB. For example, in some cases, a MIB or SIB of a CD-SSB can include a scalar value that may indicate a harmonic of the periodicity of the CD-SSB at which NCD-SSBs are broadcast. For example, if a CD-SSB has a periodicity of 20 ms, and the MIB or SIB includes a scalar value of 2, the RedCap UE may determine that an NCD-SSB has a periodicity of 40 ms. In another example, if a CD-SSB has a periodicity of 20 ms, and the MIB or SIB includes a scalar value of 3, the RedCap UE may determine that a corresponding NCD-SSB has a periodicity of 60 ms. In yet other examples, a MIB or SIB may define a schedule or pattern. For example, a first NCD-SSB may be transmitted 20 ms after a first CD-SSB, a second NCD-SSB may be transmitted 40 ms thereafter, a third may be transmitted 60 ms thereafter, and so on. In some cases, an NCD-SSB can be transmitted at an interval based on a frame index of the CD-SSB.

In yet other cases, a RedCap UE can adopt other assumptions beyond timing/frequency information describing an NCD-SSB. For example, a RedCap UE can imply a quasi-co-location restriction (QCL restriction) and/or other channel estimation parameters to NCD-SSBs based on a received CD-SSB (or prior-received NCD-SSBs), assuming that physical channel parameters influencing CD-SSB and NCD-SSB transmission from a particular cell to the RedCap UE are substantially equivalent. Similarly, a RedCap UE may presume a beam index of a particular received CD-SSB is, or can be approximated to be equivalent to a beam index of a corresponding NCD-SSB.

More generally, in many cases, a RedCap UE can assume that an NCD-SSB is provided by the same cell as a CD-SSB, despite that the NCD-SSB does not identify and/or is not specifically associated with any particular cell.

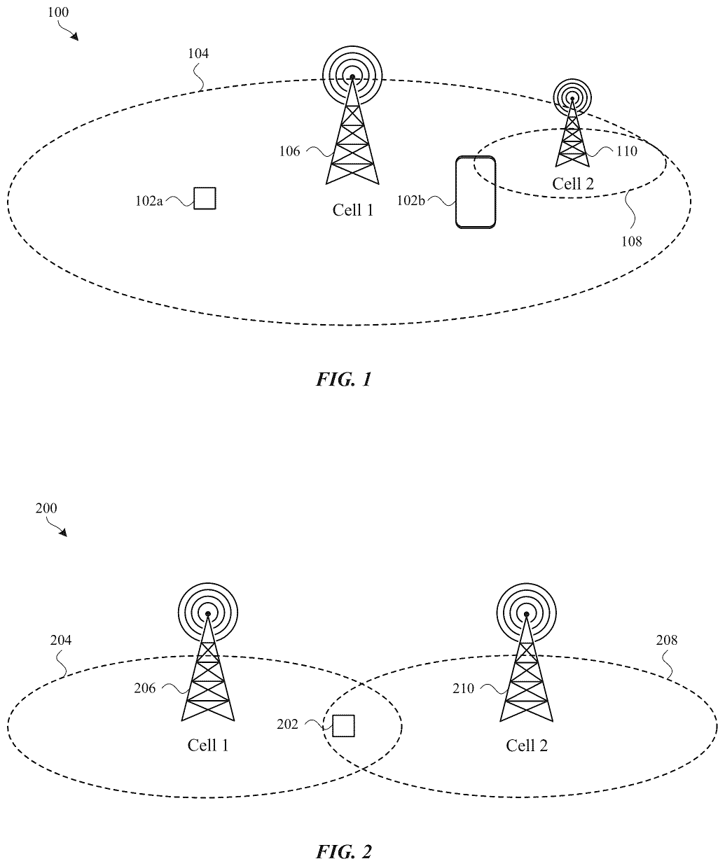

These foregoing and other embodiments are discussed below with reference to FIGS. 1-10. However, those skilled in the art will readily appreciate that the detailed description given herein with respect to these figures is for explanation only and should not be construed as limiting.

As noted above, various embodiments are described with regard to a RedCap UE. However, reference to a RedCap UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

FIG. 1 shows a scenario 100 (Scenario 1) in which a RedCap UE 102 is within the coverage area 104 for Cell 1 (represented by a base station 106). In this example, the RedCap UE 102 may be stationary, mobile, or any suitable electronic device or component of any suitable electronic device. In this configuration, the RedCap UE 102 can be positioned to receive one or more CD-SSBs broadcast by the base station 106. Each CD-SSB can include a PBCH that in turn includes a MIB or SIB, which attributes or other information that can be used by the RedCap UE 102 to locate an NCD-SSB, which may be in a different frequency band than the received CD-SSB.

As noted above, an NCD-SSB may be network-specific and not cell-specific or cell-defining. For example, FIG. 2 shows a scenario 200 (Scenario 2) in which a RedCap UE 202 is within the coverage area of two separate cells, identified in FIG. 2 as Cell 1 and Cell 2. In particular, the RedCap UE 202 may be within a coverage area 204 of Cell 1 (represented by a base station 206) and also within a coverage area 208 of Cell 2 (represented by a base station 210). In this configuration, the RedCap UE 202 can be positioned to receive one or more CD-SSBs broadcast by the base station 206 or the base station 210. As with previous embodiments, each received CD-SSB can include a PBCH that in turn includes a MIB and/or SIB, which attributes or other information that can be used by the RedCap UE 202 to locate an NCD-SSB broadcast by either or both the base station 206 or the base station 210. It may be appreciated that although the RedCap UE 202 can receive NCD-SSBs and CD-SSBs from either or both Cell 1 or Cell 2, for simplicity of description, the embodiments that follow reference a scenario in which a single RedCap UE is within a coverage area of a single serving cell, such as the scenario 100 as shown in FIG. 1.

Returning to FIG. 1, in some embodiments, the RedCap UE 102 can receive a CD-SSB, extract a MIB and/or SIB from the PBCH and determine that an NCD-SSB is broadcast 10 ms after each CD-SSB. In other cases, the MIB and/or SIB can identify for the RedCap UE 102 a frequency/time location of an NCD-SSB. In yet other cases, the MIB and/or SIB can include information that reduces search space in a sync raster; thereafter, the RedCap UE can traverse the reduced sync raster to identify a time/frequency location of an NCD-SSB.

In some cases, the CD-SSB and the NCD-SSB broadcast by the base station 106 are within the same half-frame of the same System Frame Number (SFN), in non-overlapping frequencies. In this example, once the RedCap UE 102 acquires a frame index for the CD-SSB, the RedCap UE 102 can skip half-frame index acquisition operations when capturing a corresponding NCD-SSB. This configuration can save significant time and resources for the RedCap UE 102.

In other examples, a CD-SSB and an NCD-SSB may have different periodicities. In such examples, transmission of the CD-SSB and the NCD-SSB may overlap in time whenever said periodicities align. For example, if the base station 106 broadcasts CD-SSBs at a periodicity of 20 ms, and broadcasts NCD-SSBs with a periodicity of 40 ms, every other CD-SSB will overlap with a broadcast of an NCD-SSB. As noted above, this may be suboptimal in certain scenarios in which the base station 106 determines it necessary to boost power when broadcasting either or both the CD-SSBs or NCD-SSBs.

Accordingly, in some embodiments, the base station 106 may be configured to broadcast NCD-SSBs in a different half frame from the CD-SSBs. In yet other examples, NCD-SSBs may be broadcast at a fixed offset from each CD-SSB; the offset may be defined within a MIB extracted from the CD-SSB.

In yet other examples, a network may define a particular relationship between CD-SSBs locations within the sync raster and NCD-SSBs within the same sync register. In this manner, a UE such as the RedCap UE 102 can leverage a lookup table to convert timing/frequency information associated with a received CD-SSB into timing/frequency information associated with an NCD-SSB.

In some cases, NCD-SSBs can be broadcast in different half-frames from CD-SSBs only when a collision is predicted to occur. In other words, every N broadcast of an NCD-SSB may be offset by a certain amount to avoid a collision with broadcast of a CD-SSB.

As noted above, the RedCap UE 102 can adopt a number of assumptions from a received CD-SSB that can be applied to subsequently-received NCD-SSBs, thereby saving potentially duplicative processing operations. For example, a CD-SSB's position in burst (e.g., index in a burst set) may be presumed to be identical to an NCD-SSBs PositionInBurst. Similarly, SSB-toMeasure should be presumed by the RedCap UE 102 to be identical for CD-SSB and NCD-SSB. In other phrasings, a CD-SSB can define measurement objects and/or measurement gaps that can inform an operation of a RedCap UE when that RedCap UE is exclusively monitoring NCD-SSBs thereafter.

For example, the RedCap UE 102 can assume to apply identical restrictions and/or channel properties to received NCD-SSBs as CD-SSBs. Example restrictions include quasi-co-located (QCL) restrictions. Other example restrictions may be channel parameter estimations determined from CD-SSB information. In a simpler phrasing, for many embodiments described herein, the RedCap UE 102 can assume that any received NCD-SSB is transmitted by the same physical cell as a previously received CD-SSB.

Other embodiments can apply different QCL restrictions to NCD-SSBs based on information obtained from, or with, a previously received CD-SSB. For example, a Type D QCL restriction may be applied to assume a spatial similarity between a transmitter of a CD-SSB and an NCD-SSB. In another example, Types A, B, or C QCL restrictions may cause a UE to assume that an NCD-SSB shares time and/or frequency information with a CD-SSB.

In other cases, a QCL restriction may dictate that an NCD-SSB shares a same beam (e.g., beam index) with an NCD-SSB. In other cases, for the same physical cell, an NCD-SSB may collide with a CD-SSB in the time domain, which in turn may trigger a QCL restriction between the NCD-SSB and the overlapping CD-SSB.

In yet other cases, PSS and SSS sequences associated with a CD-SSB (and/or same physical cell id (PCI) can be applied from a CD-SSB to an NCD-SSB. In these examples, the network can indicate that a PCI is for an NCD-SSB, or in some cases, the network can configure a UE to apply an index offset to CD-SSB PCI, thereby determining or inferring an NCD-SSB PCI.

These foregoing embodiments depicted in FIGS. 1-2 and the various alternatives thereof and variations thereto are presented, generally, for purposes of explanation, and to facilitate an understanding of various configurations and constructions of a system, network, UE, and/or base station/cell, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, it may be appreciated that a UE as described herein may be configured to leverage CD-SSB and/or NCD-SSB for any suitable operation or task necessary or optional for operation of that UE. In some cases, a non-RedCap UE may leverage one or more methods described herein to acquire an NCD-SSB. For example, in some cases, a full capability UE may be configured to transition to a low power mode or idle mode in which NCD-SSBs are monitored in place of CD-SSBs. In other cases, a RedCap UE can be configurable to monitor CD-SSBs exclusively (and/or alongside NCD-SSBs) until a trigger event or user or operator input causes the RedCap UE to monitor NCD-SSBs.

As such, generally and broadly, it may be appreciated that a base station and/or network configured to transmit NCD-SSBs as described herein. Similarly, any suitable RedCap UE and/or full capability UE can be configured to locate, monitor for, and/or take measurements (e.g., specified measurement gaps, measurement objects, and so on) with or against any NCD-SSB as described herein.

Similarly, an NCD-SSB can be configured to include a number of data items or attributes in, for example, a MIB encoded into PBCH. For example, in some embodiments, an MIB of an NCD-SSB can include, without limitation, information or data corresponding to: Logical Channel; Transport Channel; Physical Channel; RLC Mode; Size of Master Information Block; Resource Block Requirement; Location in Resource Grid; Channel Coding; Rate matching; Modulation; and so on.

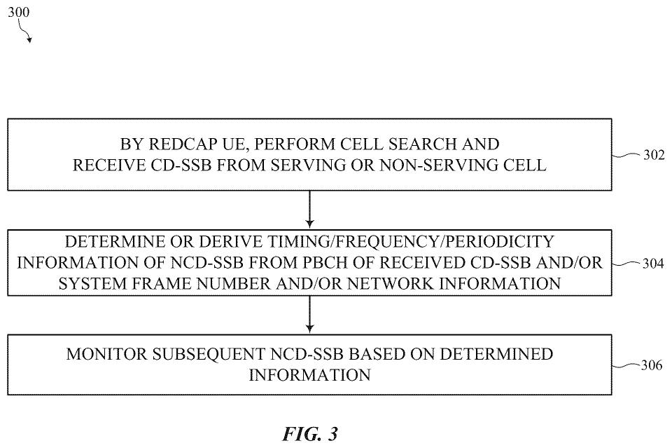

Generally and broadly, FIGS. 3-7 depict simplified flow charts that correspond to methods of operating a UE, such as a RedCap UE, and/or methods of operating a 5G NR network supporting a RedCap UE such as described herein.

FIG. 3 is a simplified flow chart corresponding to a method of operating a RedCap UE, such as described herein. The method 300 can be performed, in whole or in part, by any suitable computing resource of any suitable UE although in many embodiments of described herein may be performed by a RedCap UE such as described above.

For example, in some embodiments, operations of the method 300 can be performed by an instance of software instantiated over a processor and/or a memory of a RedCap UE such as described herein. As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements. As described herein, the term “memory” refers to any software and/or hardware-implemented data storage device or circuit physically and/or structurally configured to persistently and/or addressably store one or more digital data times, as binary information, as databases, classes, or objects.

More generally, the instance of software may be a firmware application, a kernel-level or OS-level application, or an application layer application or a combination thereof. The instance can be configured to interoperate with one or more physical components such as an RF signal processing chain, as one example. In other cases, a RedCap UE may be defined at least in part by cooperation of multiple electronic components, or discrete electronic devices either directly or wirelessly intercoupled. As such, more generally, it may be appreciated herein that a RedCap UE can be defined herein by interoperation of one or more computing resources (such as processors, memory, networking/backhaul communication components, and so on) some of which may be enclosed in a single housing, some of which may be communicably intercoupled with other nearby or remote electronic devices.

As used herein, the term “computing resource” (along with other similar terms and phrases, including, but not limited to, “computing device”) refers to any physical and/or virtual electronic device or machine component, or set or group of interconnected and/or communicably intercoupled physical and/or virtual electronic devices or machine components, suitable to execute or cause to be executed one or more arithmetic or logical operations on digital data.

Example computing resources that can include and/or may partially define a RedCap UE or other UE as described herein and as contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

In addition, as noted above, physical hardware defining a RedCap UE or other UE as described herein can be implemented in whole or in part in software. In such examples, instances of purpose-configured software, whether accessible via API as a request-response service, an event-driven service, or whether configured as a self-contained data processing service are understood as not exhaustive. In other words, a person of skill in the art may appreciate that the various functions and operations of a UE such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on.

Each of the various functions of a RedCap UE or other UE described herein can be implemented in the same manner (as one example, leveraging a common language and/or design), or in different ways. In many embodiments, functions of a UE described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted or open data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment.

The method 300 includes operation 302 in which a RedCap UE (and/or a processor thereof, or an instance of software instantiated thereon or thereby) initiates a cell search operation to receive a CD-SSB from a serving or a non-serving cell. In this construction, as known to a person of skill in the art, the RedCap UE must necessarily be located within a service area of the serving cell or non-serving cell.

To perform the cell search operation, the RedCap UE at operation 302 may be configured to traverse a sparse sync raster, optionally reconfiguring RF signal processing chains to synchronize with CD-SSBs broadcast by a cell defining a service area in which the RedCap UE is located.

Once the RedCap UE detects a CD-SSB, information can be parsed therefrom and the RedCap UE can synchronize to the broadcasting cell. For example, the RedCap UE may adopt a particular half-frame assumption with respect to the timing of the received CD-SSB; if the RedCap UE assumes that the CD-SSB that was received was broadcast in the second half-frame, the RedCap UE may expect a subsequent CD-SSB to also be broadcast in the same half-frame.

The method 300 also includes operation 304 at which information about a corresponding NCD-SSB can be inferred, calculated, or otherwise derived from timing/frequency information of the CD-SSB itself and/or from information encoded in the CD-SSB itself.

For example, in some embodiments, the RedCap UE may be pre-coded with a configuration map (e.g., a lookup table) that correlates certain CD-SSB timing/frequency locations with corresponding timing/frequency information of NCD-SSB. In this manner, once the RedCap UE identifies a CD-SSB, the timing/frequency information of that CD-SSB can be provided as input to query the lookup table which can return timing/frequency information of a corresponding NCD-SSB.

In another example, the RedCap UE can be configured to monitor for an NCD-SSB after a fixed delay has elapsed form a CD-SSB. For example, NCD-SSBs may be broadcast 5 ms after CD-SSBs.

In yet other cases, a system frame number (SFN) in which a particular received CD-SSB is received (either in the first half of the frame or the second half of the frame) can inform the RedCap UE of a corresponding location of an NCD-SSB. For example, in some cases, if a CD-SSB is broadcast in the second half frame of SFN 1, the RedCap UE can presume that an NCD-SSB will be broadcast in the first half frame of SFN 1. In other cases, the RedCap UE can make a different determination based on the CD-SSB's frame number.

More generally, it may be appreciated that operation 304 of method 300 can be performed in a number of suitable ways; in some cases, a network configuration (either preloaded to a RedCap UE or communicated to the RedCap UE in the field) can correlate particular time/frequency information of an NCD-SSB with time/frequency information of a received CD-SSB. In other cases, information extracted from (e.g., MIB) and/or based on a received CD-SSB can be used to locate an NCD-SSB.

Once an NCD-SSB is located, the RedCap UE can thereafter monitor for subsequent NCD-SSBs at operation 306. As noted above, the periodicity of the NCD-SSBs received and monitored at operation 306 may be different from the periodicity of CD-SSBs received at operation 302.

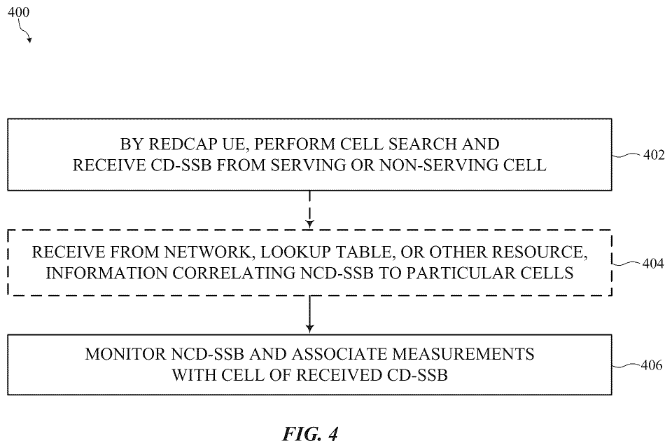

FIG. 4 is a simplified flow chart corresponding to another method of operating a RedCap UE, such as described herein. As with other embodiments described herein, the method 400 can be performed by any suitable hardware or software or combination thereof that may be associate with a RedCap UE such as described above in reference to FIG. 3; this description is not repeated.

As with the method 300, the method 400 includes operation 402 at which a RedCap UE may be configured to locate a CD-SSB, for example by traversing a sync raster.

Once a CD-SSB has been received, the method 400 can advance (optionally) to operation 404 at which the RedCap UE may associate a cell identified/defined by the CD-SSB to subsequently received NCD-SSBs. For example, as noted above, the RedCap UE may be configured to presume that an NCD-SSB received in an expected time/frequency location determined based on a received CD-SSB may be presumed to originate from the same physical cell as the original CD-SSB, which in turn can benefit the RedCap UE (e.g., by permitting the RedCap UE to make assumptions about physical channel parameters, QCI restrictions, beam indexes, and so on.

In other cases, operation 404 may include a step in which the RedCap UE accesses a lookup table to associate a particular NCD-SSB with a particular physical cell. This information can be encoded in a MIB of the NCD-SSB, a MIB of the CD-SSB, or may be provided by network configuration information received at a different time.

Thereafter, once an NCD-SSB is located (see, e.g., FIG. 3), the RedCap UE can thereafter monitor for subsequent NCD-SSBs at operation 406. As noted above, the periodicity of the NCD-SSBs received and monitored at operation 406 may be different from the periodicity of CD-SSBs received at operation 402.

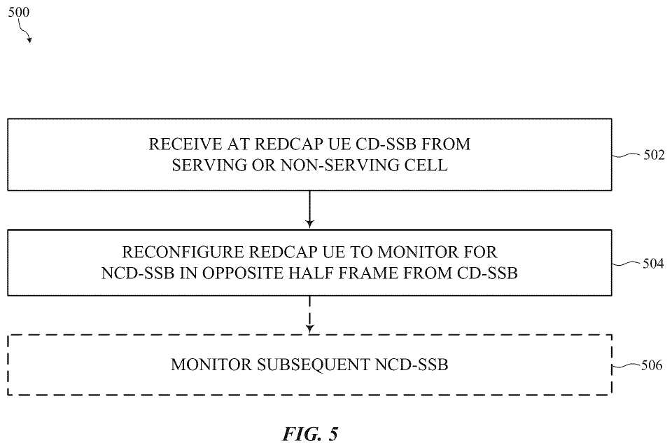

FIG. 5 is a simplified flow chart corresponding to another method of operating a RedCap UE, such as described herein. The method 500 can be performed by any suitable hardware or software or combination thereof that may be associate with a RedCap UE such as described above in reference to FIG. 3; this description is not repeated.

As with the methods 300 and 400, the method 500 includes operation 502 at which a RedCap UE may receive a CD-SSB from either a serving cell or a non-serving cell. In this example, at operation 504, the RedCap UE may presume that an NCD-SSB can be found in an opposite half-frame (in the same SFN) from the half-frame in which the received CD-SSB was received. As such, thereafter (optionally), at operation 506, the RedCap UE can monitor the opposite half-frame to receive NCD-SSBs.

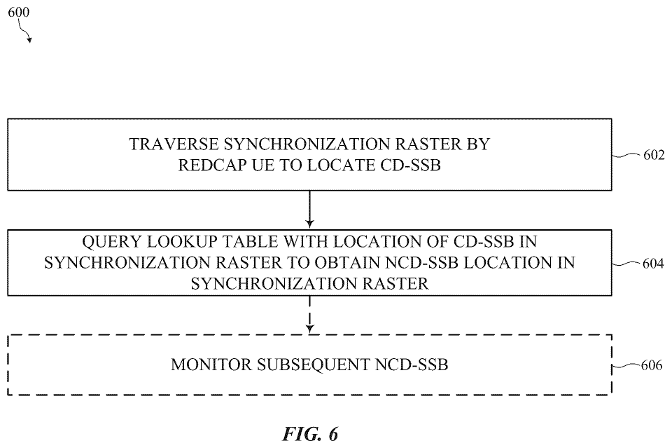

FIG. 6 is a simplified flow chart corresponding to another method of operating a RedCap UE, such as described herein. As with other embodiments described herein, the method 600 can be performed by any suitable hardware or software or combination thereof that may be associate with a RedCap UE such as described above in reference to FIG. 3; this description is not repeated.

The method 600 includes operation 602 at which a RedCap UE traverses a sync raster to locate time/frequency information of a CD-SSB. Thereafter, at operation 604, a lookup table can be queried to determine one or more sync raster locations to search to identify/locate a network-specific NCD-SSB. Thereafter, at operation 606, the RedCap UE can thereafter monitor for NCD-SSBs and act and/or measure thereon/therewith according to one or more of the various embodiments described herein.

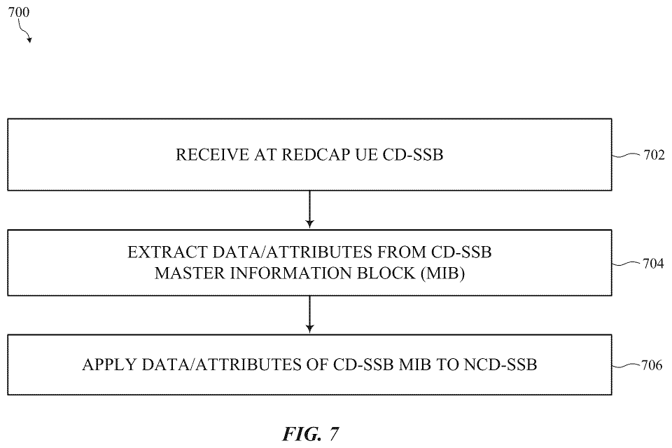

FIG. 7 is a simplified flow chart corresponding to another method of operating a RedCap UE, such as described herein. As with other embodiments described herein, the method 700 can be performed by any suitable hardware or software or combination thereof that may be associate with a RedCap UE such as described above in reference to FIG. 3; this description is not repeated. In this example embodiments, at operation 702 a CD-SSB can be received. Thereafter, at operation 704, information such as PositionInBurst and/or ToMeasure bitmaps can be extracted and automatically applied to subsequently received NCD-SSB, such as shown at operation 706.

These foregoing embodiments are not exhaustive. Further, it may be appreciated that for each of the foregoing described example methods of operating a RedCap UE, a corresponding method of operating a base station may be likewise implemented. For example, in embodiments/implementations in which a RedCap UE is configured to detect an NCD-SSB with a different half-frame assumption than a CD-SSB, it may be appreciated that a base station that broadcasts each or either SSB can be configured to broadcast the NCD-SSB in a time/frequency/half-frame location excepted by the RedCap UE. As such, a person of skill in the art may readily appreciate that each of the preceding methods (e.g., FIGS. 3-7) correspond to methods of operating a base station as well.

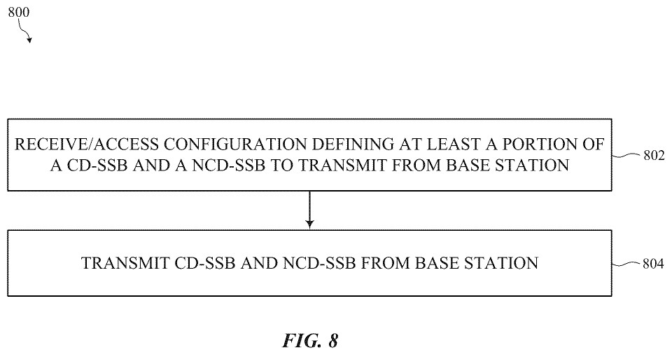

FIG. 8 depicts a simplified flow chart corresponding to operations of a method of operating a base station as described herein. As with preceding methods, the method 800 can be performed in whole or in part by operation of an instance of software instantiated at least in part by interoperation of an allocation of processing and memory resources, such as a physical processor and one or more physical memories of a cellular base station. In other cases, the method 800 can be configured to operate and/or be performed by purpose-configured hardware and/or a purpose-configured hardware appliance.

The method 800 includes operation 802 at which a network configuration is received and/or accessed by a base station, such as described herein. In some examples, this configuration can be pushed to the base station or, in some cases, a base station can access the configuration from memory. The configuration can include any suitable number of operational parameters, such as time/frequency information corresponding to transmission of a CD-SSB and/or an NCD-SSB. Thereafter, at operation 804 the base station can implement the configuration and can broadcast each of a CD-SSB and an NCD-SSB according to the configuration.

Such embodiments and methods of operating a RedCap UE as contemplated herein generally and broadly include an apparatus having means to perform one or more elements of the method 300, 400, 500, 600 or 700. In the context of certain methods of operating a UE such as a RedCap UE, this apparatus may be, for example, an apparatus of a UE (such as a wireless device 1002 that is a UE, as described herein). In the context of certain methods of operating a cell base station, this apparatus may be, for example, an apparatus of a base station (such as a network device 1020 that is a base station, as described herein).

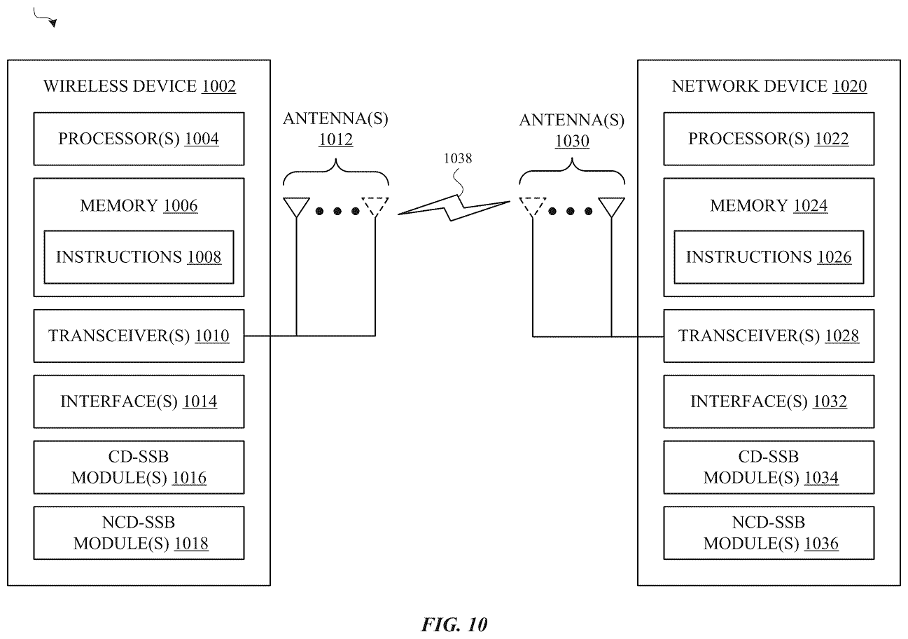

Embodiments contemplated herein include one or more non-transitory computer-readable media storing instructions to cause an electronic device, upon execution of the instructions by one or more processors of the electronic device, to perform one or more elements of the method 300, 400, 500, 600 or 700. In the context of any of these methods, this non-transitory computer-readable media may be, for example, a memory of a UE (such as a memory 1006 of a wireless device 1002 that is a UE, or RedCap UE as described herein; see, e.g., FIG. 10). In other examples, this non-transitory computer-readable media may be, for example, a memory of a base station (such as a memory 1024 of a network device 1020 that is a base station, as described herein; see, e.g., FIG. 10).

Embodiments contemplated herein include an apparatus having logic, modules, or circuitry to perform one or more elements of the method 300, 400, 500, 600 or 700. In the context of certain methods of operating a UE such as a RedCap UE, this apparatus may be, for example, an apparatus of a UE (such as a wireless device 1002 that is a UE, as described herein). In the context of certain methods of operating a cell base station, this apparatus may be, for example, an apparatus of a base station (such as a network device 1020 that is a base station, as described herein; see, e.g., FIG. 10).

Embodiments contemplated herein include an apparatus having one or more processors and one or more computer-readable media, using or storing instructions that, when executed by the one or more processors, cause the one or more processors to perform one or more elements of the method 300, 400, 500, 600 or 700. In the context of certain methods of operating a UE such as a RedCap UE, this apparatus may be, for example, an apparatus of a UE (such as a wireless device 1002 that is a UE, as described herein; see, e.g., FIG. 10). In the context of the certain methods of operating a cell base station, this apparatus may be, for example, an apparatus of a base station (such as a network device 1020 that is a base station, as described herein; see, e.g., FIG. 10).

Embodiments contemplated herein include a signal as described in or related to one or more elements of the method 300, 400, 500, 600 or 700.

Embodiments contemplated herein include a computer program or computer program product having instructions, wherein execution of the program by a processor causes the processor to carry out one or more elements of the method 300, 400, 500, 600 or 700. In the context of certain methods of operating a UE such as a RedCap UE, the processor may be a processor of a UE (such as a processor(s) 1004 of a wireless device 1002 that is a UE, as described herein; see, e.g., FIG. 10), and the instructions may be, for example, located in the processor and/or on a memory of the UE (such as a memory 1006 of a wireless device 1002 that is a UE, as described herein). In the context of certain methods of operating a cell base station, the processor may be a processor of a base station (such as a processor(s) 1022 of a network device 1020 that is a base station, as described herein; see, e.g., FIG. 10), and the instructions may be, for example, located in the processor and/or on a memory of the base station (such as a memory 1024 of a network device 1020 that is a base station, as described herein; see, e.g., FIG. 10).

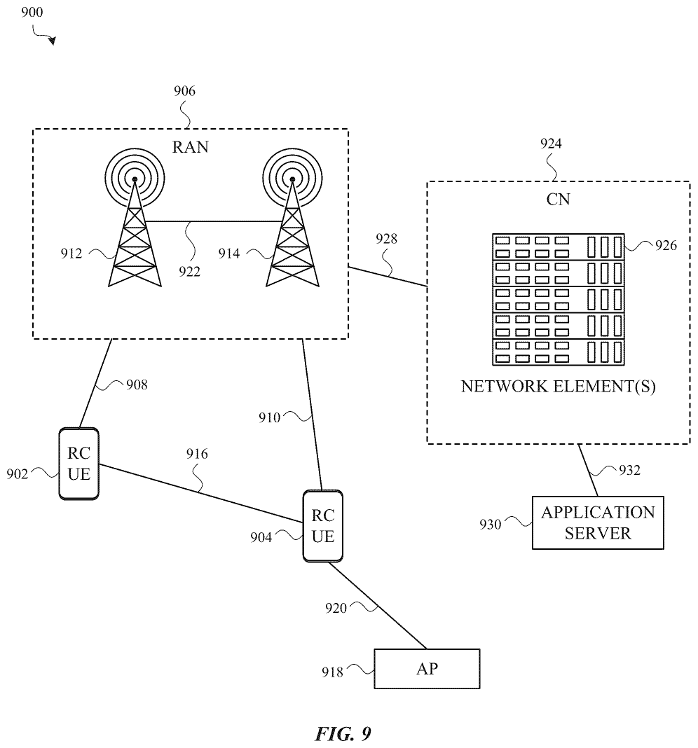

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes RedCap UE 902 and RedCap UE 904 (although any number of UE may be used). In this example, the RedCap UE 902 and the RedCap UE 904 are illustrated as smartphones (e.g., handheld touchscreen mobile computing devices connectable to one or more cellular networks), but may also comprise any mobile or non-mobile computing device configured for wireless communication.

The RedCap UE 902 and RedCap UE 904 may be configured to communicatively couple with a RAN 906. In embodiments, the RAN 906 may be NG-RAN, E-UTRAN, etc. The RedCap UE 902 and RedCap UE 904 utilize connections (or channels) (shown as connection 908 and connection 910, respectively) with the RAN 906, each of which comprises a physical communications interface. The RAN 906 can include one or more base stations, such as base station 912 and base station 914, that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the RedCap UE 902 and RedCap UE 904 may also directly exchange communication data via a sidelink interface 916. The RedCap UE 904 is shown to be configured to access an access point (shown as AP 918) via connection 920. By way of example, the connection 920 can comprise a local wireless connection, such as a connection consistent with any IEEE 902.11 protocol, wherein the AP 918 may comprise a Wi-Fi® router. In this example, the AP 918 may be connected to another network (for example, the Internet) without going through a CN 924.

In embodiments, the RedCap UE 902 and RedCap UE 904 can be configured to communicate using orthogonal frequency division multiplexing (OFDM) communication signals with each other or with the base station 912 and/or the base station 914 over a multicarrier communication channel in accordance with various communication technique, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of RedCap UE 902 and RedCap UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VOIP sessions, group communication sessions, etc.) for the RedCap UE 902 and RedCap UE 904 via the CN 924. The application server 930 may communicate with the CN 924 through an IP communications interface 932.

FIG. 10 illustrates a system 1000 for performing signaling 1038 between a wireless device 1002 and a network device 1020, according to embodiments disclosed herein. The system 1000 may be a portion of a wireless communications system as herein described. The wireless device 1002 may be, for example, a UE of a wireless communication system. The network device 1020 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1038) to and/or from the wireless device 1002 with other devices (e.g., the network device 1020) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming technique, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include a CD-SSB module 1016 and/or NCD-SSB module 1018, each or either of which may be configured to decode and/or extract information from an SSB received by the wireless device 1002. In some cases, the modules may be configured to operate with one or more other modules of the wireless device 1002 to reconfigure RF signal processing chains to appropriate bands to receive an SSB, such as described herein.

The CD-SSB module 1016 and NCD-SSB module 1018 may be implemented via hardware, software, or combinations thereof. For example, the CD-SSB module 1016 and NCD-SSB module 1018 may be implemented as a processor, circuit, and/or instructions 1008 stored in the memory 1006 and executed by the processor(s) 1004. In some examples, the CD-SSB module 1016 and NCD-SSB module 1018 may be integrated within the processor(s) 1004 and/or the transceiver(s) 1010. For example, the CD-SSB module 1016 and NCD-SSB module 1018 may be implemented by a combination of software components (e.g., executed by a DSP or a general processor) and hardware components (e.g., logic gates and circuitry) within the processor(s) 1004 or the transceiver(s) 1010.

The network device 1020 may include one or more processor(s) 1022. The processor(s) 1022 may execute instructions such that various operations of the network device 1020 are performed, as described herein. The processor(s) 1004 may include one or more baseband processors implemented using, for example, a CPU, a DSP, an ASIC, a controller, an FPGA device, another hardware device, a firmware device, or any combination thereof configured to perform the operations described herein.

The network device 1020 may include a memory 1024. The memory 1024 may be a non-transitory computer-readable storage medium that stores instructions 1026 (which may include, for example, the instructions being executed by the processor(s) 1022). The instructions 1026 may also be referred to as program code or a computer program. The memory 1024 may also store data used by, and results computed by, the processor(s) 1022.

The network device 1020 may include one or more transceiver(s) 1028 that may include RF transmitter and/or receiver circuitry that use the antenna(s) 1030 of the network device 1020 to facilitate signaling (e.g., the signaling 1038) to and/or from the network device 1020 with other devices (e.g., the wireless device 1002) according to corresponding RATs.

The network device 1020 may include one or more antenna(s) 1030 (e.g., one, two, four, or more). In embodiments having multiple antenna(s) 1030, the network device 1020 may perform MIMO, digital beamforming, analog beamforming, beam steering, etc., as has been described.

The network device 1020 may include one or more interface(s) 1032. The interface(s) 1032 may be used to provide input to or output from the network device 1020. For example, a network device 1020 that is a base station may include interface(s) 1032 made up of transmitters, receivers, and other circuitry (e.g., other than the transceiver(s) 1028/antenna(s) 1030 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1020 may include a CD-SSB module 1034 and/or NCD-SSB module 1036. The CD-SSB module 1034 and NCD-SSB module 1036 may be implemented via hardware, software, or combinations thereof. For example, the CD-SSB module 1034 and NCD-SSB module 1036 may be implemented as a processor, circuit, and/or instructions 1026 stored in the memory 1024 and executed by the processor(s) 1022. In some examples, the CD-SSB module 1034 and NCD-SSB module 1036 may be integrated within the processor(s) 1022 and/or the transceiver(s) 1028. For example, the CD-SSB module 1034 and NCD-SSB module 1036 may be implemented by a combination of software components (e.g., executed by a DSP or a general processor) and hardware components (e.g., logic gates and circuitry) within the processor(s) 1022 or the transceiver(s) 1028.

For one or more embodiments, at least one of the components set forth in one or more of the preceding figures may be configured to perform one or more operations, technique, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1-20. (canceled)

21. A method of operating a reduced capability (RedCap) user equipment (UE) in a network, comprising:
receiving, at the RedCap UE, a cell-defining synchronization signal block (CD-SSB) transmitted at a first periodicity;
determining, from the CD-SSB, timing information corresponding to a non-cell-defining synchronization block (NCD-SSB), the NCD-SSB transmitted at a second periodicity; and
monitoring, at the RedCap UE, at the second periodicity, and after determining the timing information, for NCD-SSBs transmitted according to the timing information.

22. The method of claim 21, wherein the CD-SSB and the NCD-SSB are transmitted in a same system frame number (SFN).

23. The method of claim 22, wherein:
the CD-SSB is transmitted in a first half frame of the SFN and the NCD-SSB is transmitted in a second half frame of the SFN; or
the CD-SSB is transmitted in the second half frame of the SFN and the NCD-SSB is transmitted in the first half frame of the SFN.

24. The method of claim 22, wherein:
the CD-SSB is transmitted in a same half-frame as the NCD-SS; or
the network indicates which half-frame the NCD-SSB is transmitted in.

25. The method of claim 21, wherein the first periodicity is at least half the second periodicity.

26. The method of claim 21, wherein determining the frequency information from the CD-SSB comprises accessing a lookup table by the UE.

27. The method of claim 21, further comprising:
determining, from the CD-SSB, frequency information corresponding to the NCD-SSB; wherein,
the monitoring is performed for NCD-SSBs transmitted according to the timing and frequency information.

28. The method of claim 21, wherein:
determining the timing information from the CD-SSB comprises applying a quasi-co-location (QCL) restriction to each received NCD-SSB;
a measurement gap (MG) specific to the UE is used when CD-SSB measurement or NCD-SSB measurement needs a MG; or
the measurement based on the CD-SSB is prioritized when both CD-SSB measurement and NCD-SSB measurement needs MG.

29. A user equipment (UE), comprising:
a transceiver; and
a processor configured to:
receive via the transceiver, from a base station associated with a network, a cell-defining synchronization signal block (CD-SSB) comprising a physical broadcast channel (PBCH) encoding a master information block (MIB) and corresponding system information blocks (SIBs);
determine, from the MIB or SIB, timing information of non-cell-defining synchronization signal blocks (NCD-SSBs) transmitted in a network comprising the base station;
reconfigure the transceiver to monitor for NCD-SSBs based on the determined timing information.

30. The UE of claim 29, wherein the UE is a reduced capability (RedCap) UE.

31. The UE of claim 29, wherein the timing information is based on a fixed delay relative to a time at which the CD-SSB is received.

32. The UE of claim 29, wherein:
the processor is further configured to,
determine, from the MIB or SIB, frequency information of the NCD-SSBs transmitted in the network comprising the base station; and
the frequency information is determined from a physical resource block in which the CD-SSB is received or from the SIB of the cell transmitting this CD-SSB.

33. The UE of claim 29, wherein:
a position in burst index of the CD-SSB is equal to a position in burst index of a received NCD-SSB; or
a burst index of the NCD-SSB is an index of SSB-PositionsInBurst or SSB-ToMeasure.

34. The UE of claim 29, wherein:
the processor is configured to apply the same half frame assumptions for the CD-SSB and the NCD-SSB.

35. The UE of claim 29, wherein:
after reconfiguring the transceiver to monitor for NCD-SSBs, the processor is configured to operate the transceiver at a periodicity specific to the NCD-SSBs; or
the processor is configured to:
apply identical PCI (physical cell ID) assumptions for PSS/SSS sequence assumption for CD-SSB and the NCD-SSB;
apply different PCI assumptions for the PSS/SSS sequence assumption for CD-SSB and the NCD-SSB, and PCI of NCD-SSB is indicated by the network; or
adopt per-UE MG when CD-SSB measurement or NCD-SSB measurement requires MG; or
prioritize measurement based on CD-SSB when both CD-SSB measurement and NCD-SSB measurement require MG.

36. A method of operating a base station, comprising:
transmitting a first burst set of cell-defining synchronization signal blocks (CD-SSBs) at a first periodicity and a first timing; and
transmitting a second burst set of non-cell-defining synchronization signal blocks (NCD-SSBs) at a second periodicity and a second timing.

37. The method of claim 36, wherein the second periodicity is different from the first periodicity.

38. The method of claim 36, wherein:
per-UE measurement gap (MG) is configured to UE for MG based measurement;
data/control channel scheduling is muted on one FR when measurement is configured on other FR within same symbols; or
measurement configuration is muted on one FR when data/control channel is scheduled on other FR within same symbols.

39. The method of claim 37, wherein each CD-SSB is transmitted in a first half frame and each NCD-SSB is transmitted in a second half frame different from the first half frame.

40. The method of claim 37, wherein:
each NCD-SSB is broadcast after a fixed delay relative to a respective one CD-SSB; or
measurement configuration for the UE based on CD-SSB is prioritized when both CD-SSB measurement and NCD-SSB measurement needs MG.
